(19) United States
(12) Patent Application Publication
(10) Pub. No.: US 2007/0205086 A1
(43) Pub. Date: Sep. 6, 2007

(54) Linkage for reaction force control

(75) Inventors: Jeffry R. Meyer, Greensburg, PA (US); Jared P. Johnston, Greensburg, PA (US)

Correspondence Address: PEPPER HAMILTON LLP, ONE MELLON CENTER, 50TH FLOOR, 500 GRANT STREET, PITTSBURGH, PA, 15219, US

(73) Assignee: Pennsylvania Breaker LLC

(21) Appl. No.: 11/367,072

(22) Filed: Mar. 3, 2006

(51) Int. Cl. H01H 9/00

(52) U.S. Cl. 200/17 R

(57) ABSTRACT

A high voltage circuit breaker includes at least one interrupter for opening an electrical circuit, an operating mechanism for actuating the interrupter, a frame for support of the operating mechanism and interrupter, and a mechanical linkage for coupling the operating mechanism to the interrupter. The mechanical linkage includes a rotatable shaft. At least one force containment arm is connected to the rotatable shaft and the frame. The force containment arm has a head with a cylindrical opening for encircling the rotatable shaft and a bearing structure on an inner surface bounding the cylindrical opening.

### BACKGROUND

1. Technical Field

The disclosure contained in this document relates to a linkage for reducing the forces on rotating mechanisms, and particularly to a linkage for connecting the operating mechanism of a high voltage circuit breaker or recloser to interrupters.

2. Description of the Related Art

High voltage circuit breakers are used in the distribution of three phase electrical energy to prevent the flow of current in a circuit when a fault or other disturbance is detected. When a sensor or protective relay detects a fault or disturbance in the circuit, current-carrying contacts in each of the three phases are physically separated to prevent current flow until the circuit is clear. A recloser is similar to a circuit breaker, except that a circuit breaker opens a circuit and keeps it in the open position indefinitely, but a recloser may open and reclose the circuit several times in quick succession to allow a temporary fault to clear. (As used herein, the term “circuit breaker” may refer to either a circuit breaker or recloser.) A circuit breaker or recloser includes interrupters for physically separating the current-carrying contacts and an operating or switching mechanism for providing the energy necessary to accomplish separation of the contacts.

A linkage is provided for mechanically coupling the operating mechanism to each of the interrupters. In general, the linkages or mechanical couplings may be one of several types. For example, in a “push/pull” type coupling, conductive elements are moved into engagement when a rigid rod is moved in one direction, and the coupling elements are disengaged when the rod is moved in the opposite direction. In a rotational coupling, one of the conductive elements moves in response to the rotation of a bell crank as a link element between the three phases of the breaker rotates.

In a circuit breaker having a rotational linkage, the mechanical coupling may include one or more connecting rods, each connected at one end to an operating mechanism and at the other end to a lever. Each lever is connected to a linking element which rotates in response to pivotal movement of the lever due in turn to linear movement of the connecting rod. The linking element may be coupled to bell cranks provided in the terminal portion of the interrupters which pivot in response to rotation of the linking elements to open and close the contacts of the interrupters.

An example of such a mechanical coupling is illustrated in U.S. Pat. No. 5,569,891. FIG. 3 of this patent, which is reproduced herein as FIG. 1, shows a prior art example of a dependent pole mechanism for opening and closing all three phases of a circuit breaker simultaneously. In FIG. 1, a single connecting rod 22 connects operating mechanism 20 to two rotatable linking elements 25 and 26 by lever 24. The linking elements are coupled to bell cranks in the terminal portion of the interrupters (not shown). FIG. 4 of the patent, which is reproduced herein as FIG. 2, shows an example of a linkage for independent pole operation of the circuit breaker. In FIG. 2 herein, three independently operated connecting rods, 32, 33 and 34, are provided. Two of the connecting rods 32 and 33 are connected to lever assemblies 40 and 41 which couple the connecting rods to rotatable linking elements 37 and 39, respectively. Lever assemblies 40 and 41 also provide a mechanical bearing for decoupling connecting rods 32 and 33 from rotatable linking elements 38 and 36, respectively. The third connecting rod 34 is connected to a lever assembly that does not have a bearing for decoupling from a linking element. FIG. 6 of the patent, which is reproduced herein as FIG. 3, shows a lever assembly 40 having aperture 62 for mechanically coupling to one linking element and a hollow opening 63 with bearings 67 for decoupling from a second linking element. The lever assemblies in FIG. 3 are loading bearing and contain vertical and horizontal forces acting on the linking elements and other part of the mechanism because the levers are clamped onto the mating shafts to support these loads.

Very high forces can be generated in the linkages and levers of the mechanical coupling of high voltage circuit breakers, especially as the voltage rating of the circuit breaker increases. These high loads will create excessive stresses in the circuit breaker components and also cause flexing in these components that adversely affects motion of the interrupter. Accordingly, these components must be made massive unless something is done to otherwise contain the high forces. There is a need therefore to avoid the expense of making high voltage circuit breaker components massive as the voltage rating of the circuit breaker increases.

### SUMMARY

In one embodiment, a force containment arm is provided for containing forces acting on a rotatable shaft. The force containment arm has a head with a cylindrical opening for encircling the rotatable shaft and a bearing structure on an inner surface bounding the cylindrical opening, a connector for connecting the arm to a support frame and a stud connecting the connector to the head. In some embodiments the stud may be adjustable for adjusting the distance between the head and the connector.

In another embodiment, a linkage assembly is provided which includes a coupler for connecting two rotatable shaft portions end-to-end. The coupler has a lever for connection to an input mechanism for rotating the shaft. A pair of force containment arms is mounted on the coupler for containing reaction force acting on the shaft and other components connected to the shaft. Each force containment arm has a head with a cylindrical opening for encircling the coupler, a connector for connecting the arm to a support frame and a stud connecting the connector to the head. The head has a bearing structure on an inner surface bounding the cylindrical opening for contact with the coupler. In some embodiments, the stud may be adjustable for adjusting the distance between the head and the connector. In still other embodiments, one or more containment arms may be mounted on the rotatable shaft instead of on a coupler.

In still another embodiment, a high voltage circuit breaker is provided which includes at least one interrupter for opening an electrical circuit, an operating mechanism for actuating the interrupter, a frame for support of the operating mechanism and interrupter, and a mechanical linkage for coupling the operating mechanism to the interrupter. The mechanical linkage includes a rotatable shaft, a lever for rotating the shaft in response to the operating mechanism, a crank connected to the rotatable shaft for actuation of the interrupter, and at least one force containment arm connected to the rotatable shaft and the frame, said force containment arm having a head with a cylindrical opening for encircling said rotatable shaft and a bearing structure on an inner surface bounding the cylindrical opening, a connector for connecting the arm to a support frame and a stud connecting the connector to the head. In some embodiments, a pair of force containment arms is mounted on the rotatable shaft in spaced relation on opposite sides of the lever. In the latter embodiment, a lateral brace may be provided for attachment to each of the containment arms.

### DESCRIPTION OF THE DRAWINGS

Before explaining at least one embodiment in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting. For example, all singular forms and the words “a,” “an,” and “the” include the plural reference unless expressly stated otherwise.

FIG. 1 illustrates an exemplary prior art rotating linkage with a single connecting rod for a three-phase circuit breaker.

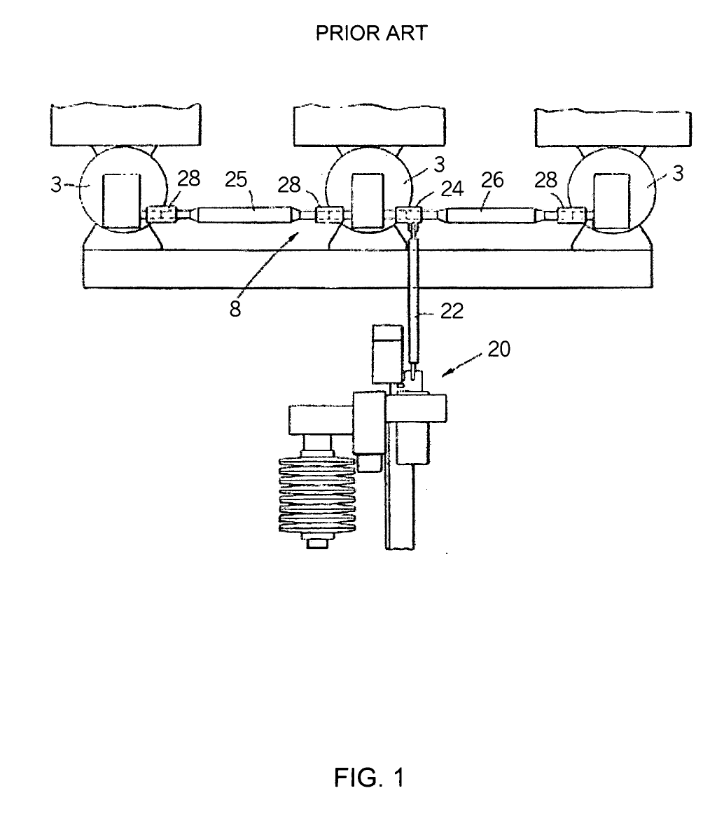

FIG. 2 illustrates an alternate prior art embodiment of FIG. 1 in which three connecting rods are used.

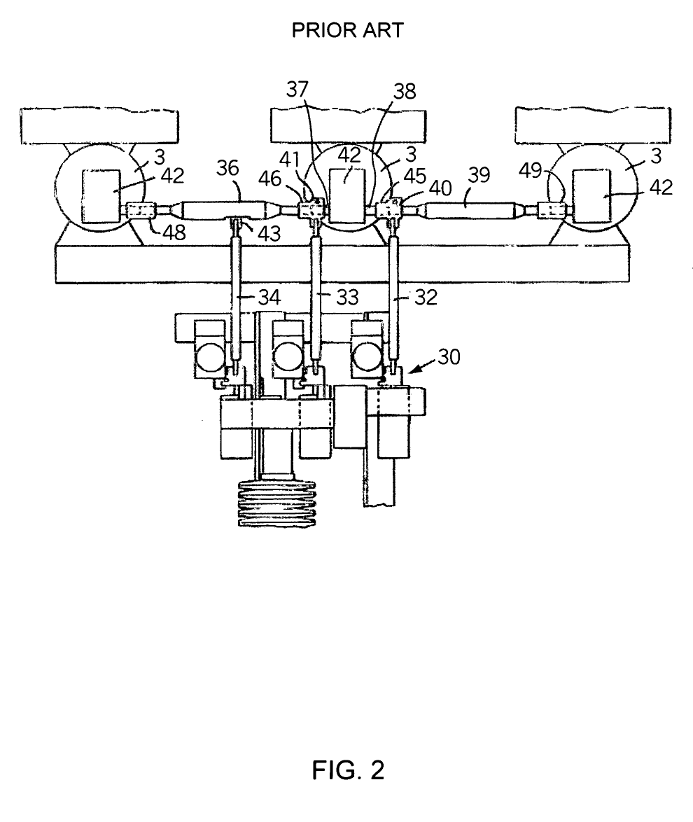

FIG. 3 illustrates a prior art lever assembly for connecting a connecting rod to a rotating link member.

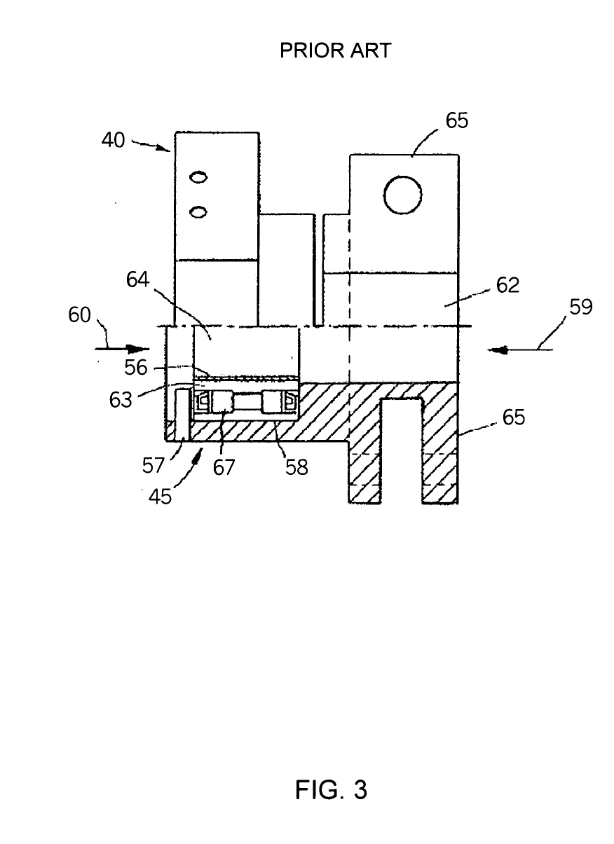

FIG. 4 is a front elevation view of a high voltage circuit breaker showing the mechanical linkage between the operating mechanism and interrupters with a pair of force containment arms for containing forces on the components of the circuit breaker.

FIG. 5 is a side view of the high voltage circuit breaker of FIG. 4.

FIG. 6 is a side view of one the force containment arms of FIG. 4.

FIG. 7 is a front view of the force containment arm of FIG. 6.

FIG. 8 is an end view of two force containment arms mounted on a coupler for connecting separate rotatable shaft portions end-to-end.

FIG. 9 is an enlarged side view of a portion of the high voltage circuit breaker of FIG. 4 with a portion of a cabinet and rotatable shaft removed for clarity.

### DETAILED DESCRIPTION

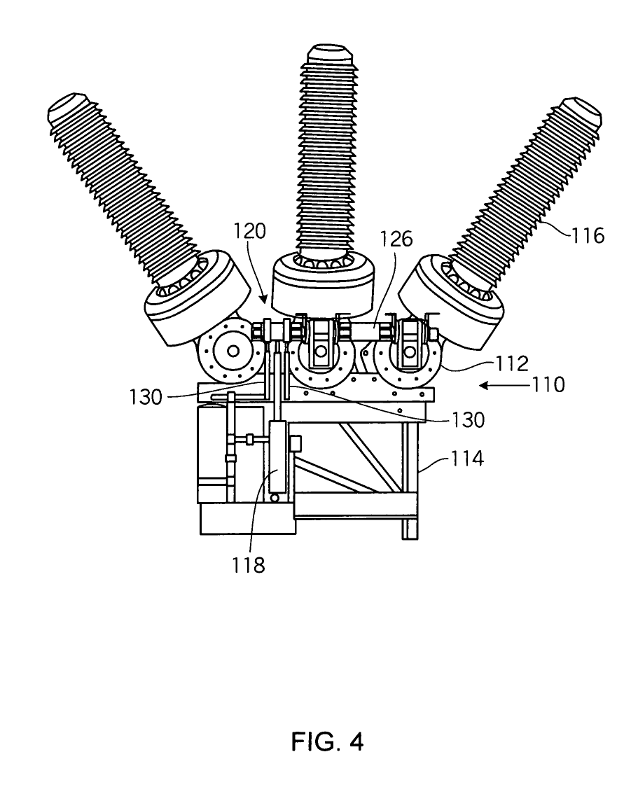

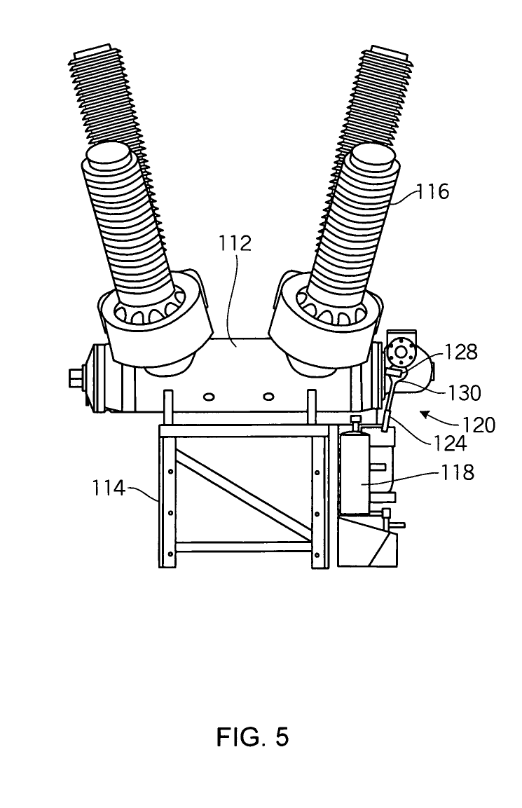

Referring to FIGS. 4 and 5, high voltage circuit breaker 110 comprises three cylindrical tanks 112 mounted on a frame 114. Each tank houses an interrupter (not shown) which has terminals connected to spaced bushing insulators 116 and movable contacts (not shown) for opening and closing an electrical circuit (not shown). An operating mechanism 118 is connected by a mechanical linkage 120 to the interrupters for moving the contacts to open and closed positions. The mechanical linkage may include a connecting rod 124 connected at one end to an output shaft (not shown) of operating mechanism 118 and at the other end to a lever. 128 on rotatable shaft assembly 126. The rotatable shaft assembly may comprise a plurality of rotatable shafts coupled end-to-end. The rotatable shaft assembly may be coupled to three spaced bell cranks (not shown) for moving the contacts in each interrupter. Vertical loads are imposed on the horizontal mechanical linkage due to loads from the operating mechanism which reach the mechanical linkage through the connecting rod. As the voltage rating of the circuit breaker increases, these loads increase to the point where massive components may be required to contain the loads and reduce or limit component flexing. In order to contain these vertical loads, a pair of force containment arms 130 may be provided for controlling reaction forces of the mechanical linkage on the circuit breaker components.

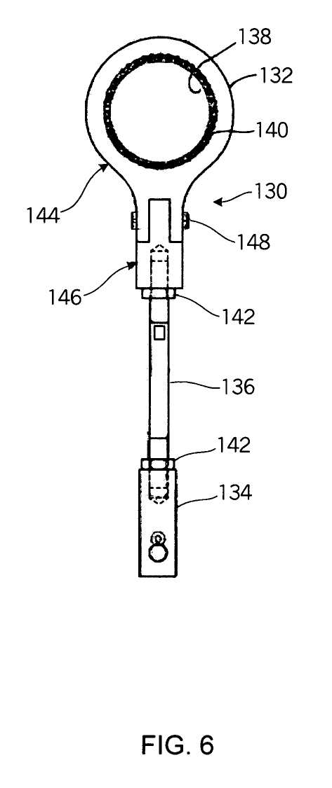

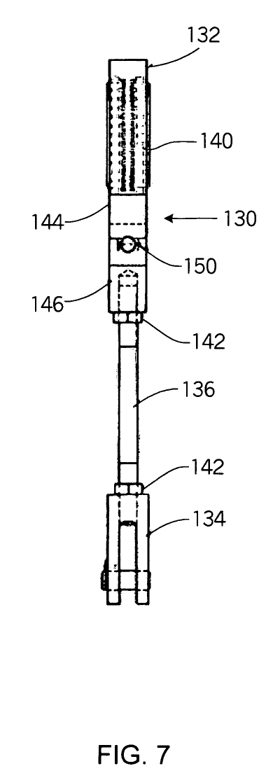

Referring to FIGS. 6 and 7, each force containment arm 130 comprises a head 132, a connector 134 and a stud 136. Head 132 has a cylindrical opening 138 for encircling rotatable shaft (126 in FIG. 4). In some embodiments a bearing structure such as a roller or sleeve bearing 140 may be provided around the inner surface of head 132 bounding cylindrical opening 138 for bearing the load of shaft assembly 126. In an embodiment, inner surface of head 132 is sized so that the bearing structure 140 contacts shaft 126. The bearing may have an inner race or may use the rotatable shaft as the inner race if desired.

In some embodiments, weather seals may be provided on each side of the bearing to prevent contamination of the bearing. Flexible lip seals, preferably made of a rubber compound, although other flexible materials are possible, are most suited for this purpose. In some embodiments connector 134 may comprise a clevis or other device for connecting the force containment arm to frame 114 near the output shaft of operating mechanism (118 in FIG. 5). In some embodiments stud 136 may be adjustable. For example, one end of the stud may have right hand threads and the other end may have left hand threads. Alternatively, both ends may have the same thread rotation for engaging threaded holes in head 132 and connector 134, respectively. Other adjustment mechanisms are possible. A nut 142 may be provided near each end of the stud to secure the stud to the head and connector. The force containment arms create a force circle sending vertical loads imposed on the mechanical linkage from the movement of operating mechanism back to the mechanism frame. In addition, support is provided for rotatable shaft 124 when operating mechanism 118 is activated, thus reducing stress on shaft 124. In this way, the vertical loads may be largely contained and the required component sizes and strengths needed for handling the vertical loads may be greatly decreased.

In various embodiments, shaft 136 may comprise a solid, corrosion-resistant or plated metal such as stainless steel, a plated steel or high strength aluminum.

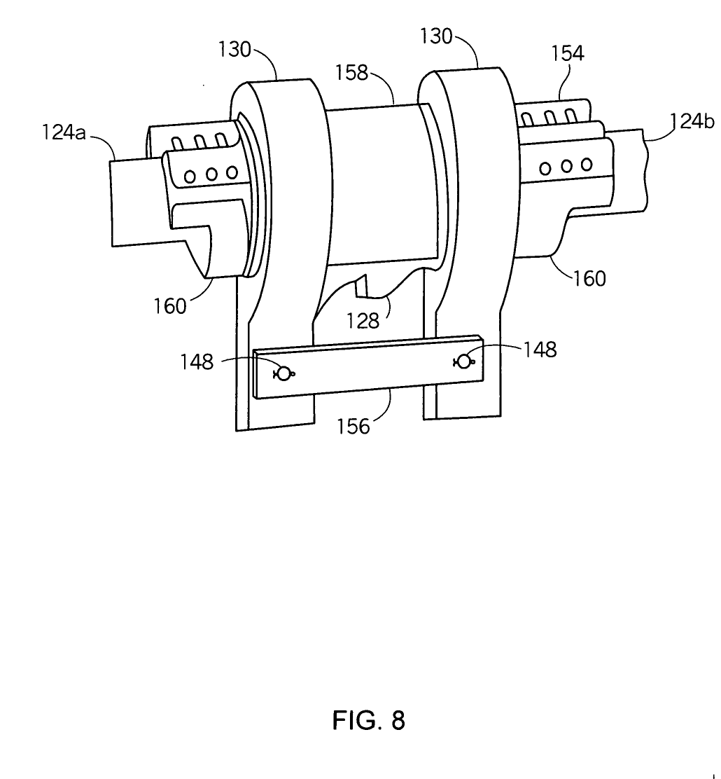

In some embodiments the head 132 may comprise two portions 144 and 146 connected by a pin 148 secured by a cotter pin 150. This makes mechanical assembly easier in situations where space is limited. In other embodiments the two head portions may be connected by a bolt and nut, screw or other connector. Similarly, a pin 152, bolt or other connector may be used to attach the connector 134 to frame 114 or other support structure. Referring to FIG. 8, in some embodiments two containment arms 130 may be mounted on a coupler 154, such as a sleeve or other member that secures two rotatable shaft portions 124a and 124b, which together form a rotatable shaft assembly 124, end-to-end. The two force containment arms 130 may be further secured together by a lateral brace 156 attached to each arm by mounting the brace on pin 148. Coupler 154 may have a center portion 158 of larger diameter than opposite end portions 160 in order to provide an end stop for each containment arm mounted on the coupler. In some embodiments coupler 154 may have a lever 128, which is integral or separately attached, for connection to shaft assembly 124.

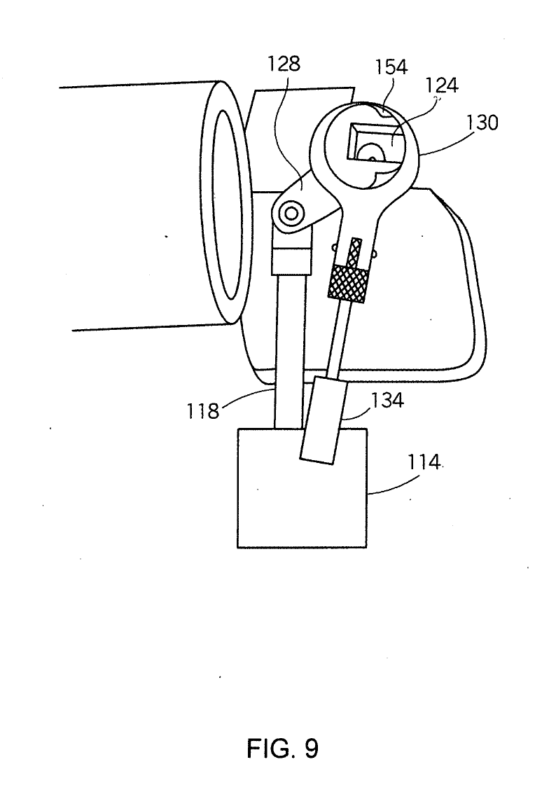

FIG. 9 illustrates a side view of an exemplary arrangement of a force containment arm 130 on a breaker with the breaker cabinet removed for clarity. Coupler 154 secures containment arm 130 to connecting rod 124. Connecting member 134, which may comprise, for example, a clevis and pin, secures force containment arm 130 to the frame 114 of the breaker or mechanism. Operating member 118 activates the bell crank (not shown) in the housing by moving lever 128 and therefore turning shaft assembly 124, which in turn rotates the bell crank.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art, each of which are also intended to be encompassed by the following claims.

What is claimed is:

1. A force containment arm for reducing reaction forces acting on a linkage containing a rotatable shaft, said force containment arm comprising:
a head with a cylindrical opening for encircling the rotatable shaft, said head having an internal bearing structure for contact with the rotatable shaft;
a first connector for connecting the arm to a support frame; and
a stud connecting the connector to the head.

2. The force containment arm of claim 1 wherein the stud is adjustable for adjusting the distance between the head and connector.

3. The force containment arm of claim 1 wherein the head comprises two head portions and a second connector for securing the two head portions together.

4. A linkage assembly, comprising:
a rotatable shaft having a lever for receiving input forces for rotating the shaft;
at least one force containment arm mounted on the rotatable shaft for containing reaction forces acting on the shaft and other components connected to the rotatable shaft;
said force containment arm having a head with a cylindrical opening for encircling the rotatable shaft and a bearing structure on an inner surface bounding the cylindrical opening for contact with the rotatable shaft;
a first connector for connecting the arm to a support frame;
and a stud connecting the connector to the head.

5. The linkage assembly of claim 4 wherein the stud is adjustable for adjusting the distance between the head and the connector.

6. The linkage assembly of claim 4 wherein the head comprises two head portions and a second connector for connecting the two head portions together.

7. The linkage assembly of claim 4 wherein a pair of force containment arms are mounted on the rotatable shaft at spaced locations along the length of the shaft.

8. The linkage assembly of claim 4 wherein the rotatable shaft comprises two rotatable shaft portions and a coupler connects the two rotatable shaft portions end-to-end, and wherein said force containment arm is mounted on said coupler.

9. The linkage assembly of claim 8 wherein a pair of force containment arms are mounted on the coupler at spaced locations along the length of the coupler.

10. The linkage assembly of claim 9 wherein the coupler has a center portion of enlarged outside diameter and the pair of force containment arms are mounted on end portions of the coupler of smaller outside diameter than the center portion, the center portion serving as a stop for each of the force containment arms.

11. The linkage of claim 9 further comprising a lateral brace secured to each of the containment arms.

12. The linkage of claim 10 further comprising a lateral brace secured to each of the containment arms.

13. The linkage of claim 11 wherein the head of each of the containment arms comprises two head portions and a second connector for securing the two head portions together, and wherein the lateral brace is secured to each of the containment arms by the second connector.

14. The linkage of claim 12 wherein head of each of the containment arms comprises two head portions and a second connector for securing the two head portions together, and wherein the lateral brace is secured to each of the containment arms by the second connector.

15. A high voltage circuit breaker which comprises:
at least one interrupter for opening and closing an electrical circuit;
an operating mechanism for actuating the interrupter;
a frame for support of the operating mechanism and interrupter; and
a mechanical linkage for coupling the operating mechanism to the interrupter, the mechanical linkage including a rotatable shaft, a lever for rotating the shaft in response to the operating mechanism, a crank connected to the rotatable shaft for actuation of the interrupter, and at least one force containment arm connected to the rotatable shaft and the frame,
the force containment arm having a head with a cylindrical opening for encircling the rotatable shaft and a bearing structure on an inner surface bounding the cylindrical opening, a first connector for connecting the arm to a support frame and a stud connecting the coupler to the head.

16. The high voltage circuit breaker of claim 15, wherein the rotatable shaft comprises at least two rotatable shaft portion connected end-to-end by at least one coupler, and wherein a pair of force containment arms are mounted on the coupler.

17. The high voltage circuit breaker of claim 16 wherein the head of each of the force containment arms comprises two head portions and a second connector for securing the two head portions together.

18. The high voltage circuit breaker of claim 16 further comprising a lateral brace secured to each of the containment arms.

19. The high voltage circuit breaker of claim 16 wherein the coupler has a center portion of enlarged outside diameter and the pair of force containment arms are mounted on end portions of the coupler of smaller outside diameter than the center portion, the center portion serving as a stop for each of the force containment arms.

20. The high voltage circuit breaker of claim 16 wherein the stud is adjustable for adjusting the distance between the head and the first connector of the force containment arm.
